(19) United States
(12) Patent Application Publication
(10) Pub. No.: US 2021/0372186 A1
(43) Pub. Date: Dec. 2, 2021

(54) Overhead Door Hinge Mechanism

(71) Applicant: GUANGDONG SACA PRECISION MANUFACTURING CO., LTD., Foshan (CN)

(72) Inventors: Gengxi Cai, Foshan (CN); Xiang Zhang, Fuyang (CN); Wenming Yang, Singapore (SG)

(21) Appl. No.: 17/399,044

(22) Filed: Aug. 10, 2021

Related U.S. Application Data
(63) Continuation of application No. PCT/CN2019/101319, filed on Aug. 19, 2019.

(30) Foreign Application Priority Data
Jul. 23, 2019 (CN) 201910667576.6

(51) Int. Cl. E05F 3/20; E05D 11/10

(52) U.S. Cl. CPC E05F 3/20; E05D 11/10

(57) ABSTRACT

The present invention discloses an overhead door hinge mechanism, comprising a hinge box boy, wherein the side wall of the hinge box body is provided with a telescopic arm assembly used for connecting with the door backplane of an overhead door, the telescopic arm assembly is provided with a two-stage rotating arm mechanism used for driving the door backplane to upwards flip over the range of a right angle, a connecting and rotating block and a spring stress block are rotationally fixed in the hinge box body, the telescopic arm assembly is rotationally fixed on the side wall of the hinge box body through the connecting and rotating block. The present invention can enable the overhead door to flip over a right angle and reduce the mechanical loss of the spring through the clamping mechanism, and has stable supporting structure and long service life.

### CROSS REFERENCE TO RELATED APPLICATIONS

The present application is a Continuation Application of PCT Application No. PCT/CN2019/101319 filed on Aug. 19, 2019, which claims the benefit of Chinese Patent Application No. 201910667576.6 filed on Jul. 23, 2019. All the above are hereby incorporated by reference in their entirety.

### FIELD OF INVENTION

The present invention relates to a hinge mechanism and particularly relates to an overhead door hinge mechanism.

### BACKGROUND ART OF THE INVENTION

A hinge is a mechanical device used for connecting two solid objects and allowing the relative rotation thereof, and an overhead door hinge is mainly used in a joint of a box body or cabinet body provided with a cover door and can realize closing and opening of the cover door on the box body.

At present, many overhead door hinges are simple door hinges, and each hinge is provided with two rotating hinge pieces which are in shaft connection. Such hinges can only perform a simple function of rotating and opening a cover door and cannot keep the position and angle of the cover door, and collision easily occurs in the opening and closing process. For some cabinet bodies needing upturned cover doors, the hinge is required to provide stable and good elastic support for the cover door to keep the upturned door in an open state. For damping hinges or spring hinges on the market, the component mainly for keeping the turning angle is a spring or damping element easy to wear, so the service life is short. For cover doors of large cabinet bodies, in case of lack of a good and stable opening supporting mechanism, it is difficult to open and close the cover door and the cabinet body. Therefore, in view of the above problems, an overhead door hinge mechanism with reasonable structure and stable cover door opening and closing is required.

### DISCLOSURE OF THE INVENTION

The purpose of the present invention is to provide an overhead door hinge mechanism to solve problems proposed in the above background art of the invention.

To achieve the above purpose, the present invention provides the following technical solution:

An overhead door hinge mechanism, comprises a hinge box boy, wherein the side wall of the hinge box body is provided with a telescopic arm assembly used for connecting with the door backplane of an overhead door, the telescopic arm assembly is provided with a two-stage rotating arm mechanism used for driving the door backplane to upwards flip over the range of a right angle, a connecting and rotating block and a spring stress block are rotationally fixed in the hinge box body, the telescopic arm assembly is rotationally fixed on the side wall of the hinge box body through the connecting and rotating block, and a clamping mechanism used for limiting the rotation of the connecting and rotating block is arranged between the spring stress block and the connecting and rotating block.

Further, the spring stress block is provided with a hinge spring used for rotationally applying pressure on the spring stress block on one side away from sliding connection with the connecting and rotating block.

Further, the two-stage rotating arm mechanism comprises a long arm support, a short arm support and a door panel fixing frame, the long arm support and the short arm support are rotationally fixed on the panel of one side of the connecting and rotating block at an interval, the outside ends of the long arm support and the short arm support are fixed on one end of the door panel fixing frame at an interval, and the panel of the door panel fixing frame relative to the rotating connection of the long arm support and the short arm support is used for fixed connection with the door backplane of the overhead door.

Further, a damper used for buffering the telescopic arm assembly during retraction and extension is arranged in the hinge box body, and the damper is rotationally connected with the connecting and rotating block.

Further, the clamping mechanism comprises a sliding groove and a rotating and sliding arc edge, the rotating and sliding arc edge is arranged in the side wall position connected with the connecting and rotating block and the spring stress block, the sliding groove is arranged in the side wall connected with the connecting and rotating block, the sliding groove is an annular opening groove, the connecting and rotating block is integrally clamped in the sliding groove through the rotating and sliding arc edge, and a bearing ring for facilitating sliding of the connecting and rotating block is sleeved in the sliding groove.

Compared with the prior art, the present invention has the beneficial effects that: the telescopic arm assembly arranged in the present invention can drive the door panel fixing frame used for fixing the door body to realize the turning from a vertical position to a horizontal position through mutual matching of the long arm support and the short arm support through two-stage rotary bending, the clamping mechanism arranged in the present invention can effectively keep the door panel fixing frame in a vertical or horizontal state to reduce mechanical loss of the hinge spring, the damper arranged in the present invention can slow down application of elastic force of the hinge spring during turning to keep the telescopic arm assembly slowly open or close as a whole, thus greatly improving the overall turning smoothness of the door panel fixing frame, and the present invention has long overall service life and can be effectively used for connection of various cover doors and cabinets needing overhead doors.

### DESCRIPTION OF THE DRAWINGS

FIG. 1 is a structural schematic diagram of an overhead door hinge mechanism.

FIG. 2 is a structural schematic diagram of a telescopic arm assembly extended to a horizontal state in an overhead door hinge mechanism.

FIG. 3 is a structural schematic diagram of a telescopic arm assembly retracted to a vertical state in an overhead door hinge mechanism.

FIG. 4 is a structural schematic diagram of an overhead door hinge mechanism installed on an overhead door body in a closed state.

FIG. 5 is a structural schematic diagram of an overhead door hinge mechanism installed on an overhead door body in an open state.

In the figures: hinge box body 1, bottom box 10, cover plate 11, accommodating groove 12, hinge spring 2, spring stress block 3, sliding groove 30, connecting and rotating block 4, sliding arc edge 40, telescopic arm assembly 5, long arm support 50, short arm support 51, door panel fixing frame 52, rotary connecting plate 520, fixed trough plate 521 and damper 6.

### DETAILED DESCRIPTION OF THE INVENTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

### Embodiment 1

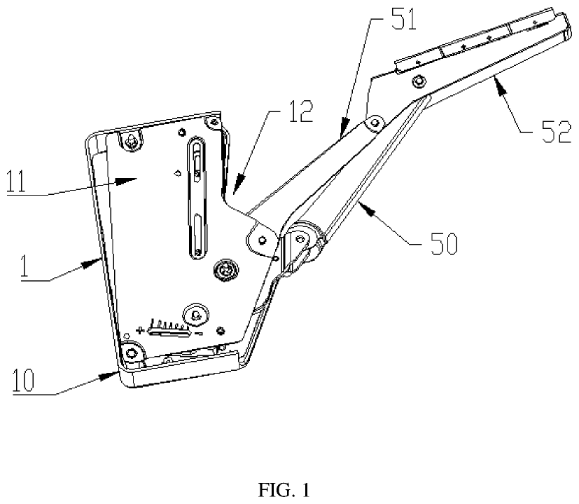

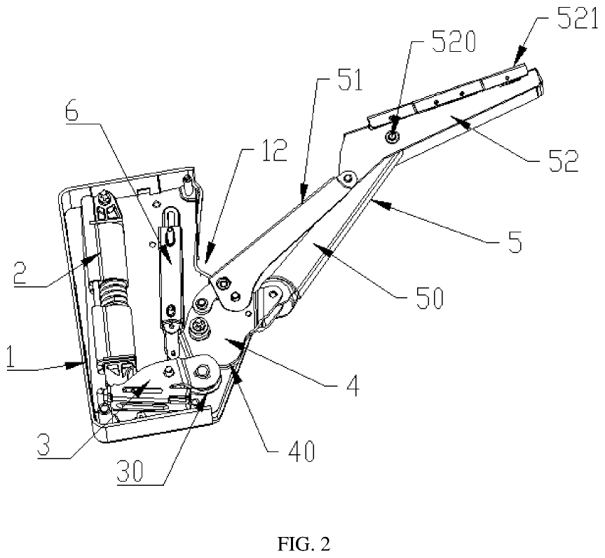

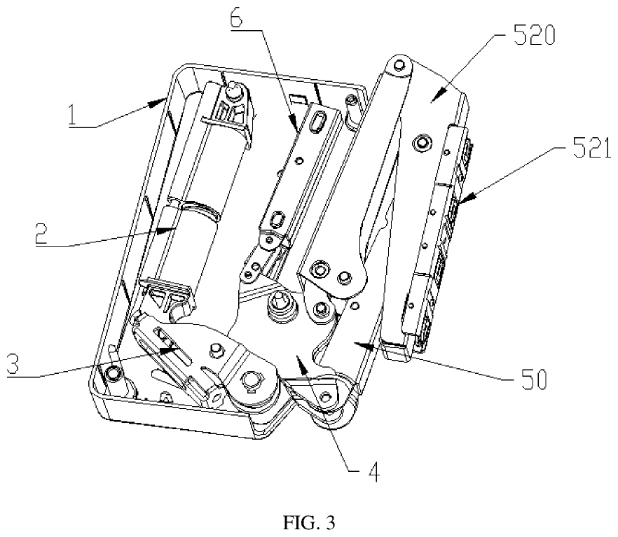

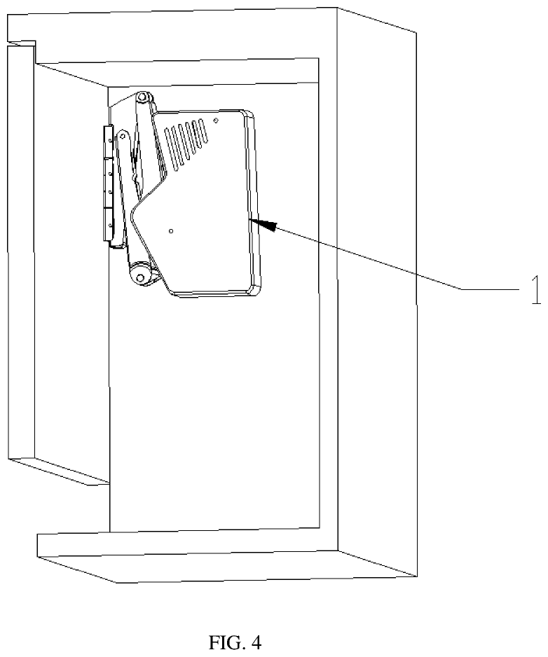

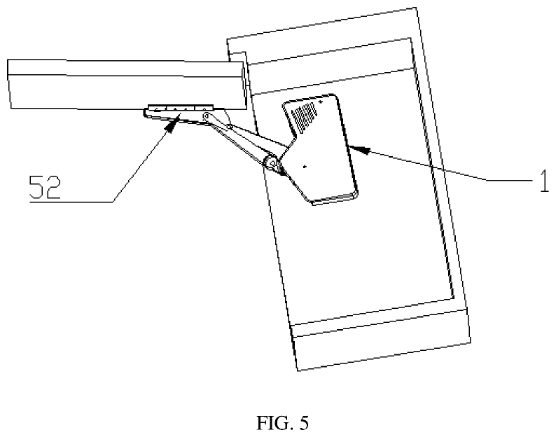

With reference to FIG. 1 to FIG. 5, in the embodiments of the present invention, an overhead door hinge mechanism, comprises a hinge box boy 1, wherein the side wall of the hinge box body 1 is provided with a telescopic arm assembly 5 used for connecting with the door backplane of an overhead door, the telescopic arm assembly 5 is provided with a two-stage rotating arm mechanism used for driving the door backplane to upwards flip over the range of a right angle, a connecting and rotating block 4 and a spring stress block 3 are rotationally fixed in the hinge box body 1, the telescopic arm assembly 5 is rotationally fixed on the side wall of the hinge box body 1 through the connecting and rotating block 4, and a clamping mechanism used for limiting the rotation of the connecting and rotating block 4 is arranged between the spring stress block 3 and the connecting and rotating block 4.

The spring stress block 3 is provided with a hinge spring 2 used for rotationally applying pressure on the spring stress block 3 on one side away from sliding connection with the connecting and rotating block 4.

The two-stage rotating arm mechanism comprises a long arm support 50, a short arm support 51 and a door panel fixing frame 52, the long arm support 50 and the short arm support 51 are rotationally fixed on the panel of one side of the connecting and rotating block 4 at an interval, the outside ends of the long arm support 50 and the short arm support 51 are fixed on one end of the door panel fixing frame 52 at an interval, and the panel of the door panel fixing frame 52 relative to the rotating connection of the long arm support 50 and the short arm support 51 is used for fixed connection with the door backplane of the overhead door.

The door panel fixing frame 52 comprises rotary connecting plates 520 and a fixed trough plate 521, the fixed trough plate 521 is trough section, the trough wall of one end of the fixed trough plate 521 is fixed with two rotary connecting plates 520 opposite to each other in parallel, and the left end and the right end of each rotary connecting plate 520 are respectively in rotary and fixed connection with the outside ends of the short arm support 51 and the long arm support 50.

The clamping mechanism comprises a sliding groove 30 and a rotating and sliding arc edge 40, the rotating and sliding arc edge 40 is arranged in the side wall position connected with the connecting and rotating block 4 and the spring stress block 3, the sliding groove 30 is arranged in the side wall connected with the connecting and rotating block 4, the sliding groove 30 is an annular opening groove, the connecting and rotating block 4 is integrally clamped in the sliding groove 30 through the rotating and sliding arc edge 40, and a bearing ring for facilitating sliding of the connecting and rotating block 4 is sleeved in the sliding groove 30.

The hinge box body 1 comprises a bottom box 10 and a cover plate 11, the cover plate 11 is covered on the bottom box 10, the bottom box 10 is provided with a notch for rotary connection of the connecting and rotating block 4 and the telescopic arm assembly 5 on the side wall located on one side of the telescopic arm assembly 5, and an accommodating groove 12 for attaching and accommodating the telescopic arm assembly 5 on the side wall of the bottom box 10 is arranged at the notch.

The present invention has the working principle that: in use, the bottom surface of the bottom box 10 of the hinge box body 1 is attached to the side wall of the box body in the overhead door body, and the hinge box body 1 is vertically installed, wherein the door panel fixing frame 52 is fixedly connected with the door backplane of the overhead door; when the short arm support 51 of the telescopic arm assembly 5 is accommodated in the accommodating groove 12, the long arm support 50 is rotationally attached to the outer side of the short arm support 51, and the door panel fixing frame 52 is rotationally attached to the outer side wall of the long arm support 50, the door body fixed on the door panel fixing frame 52 is vertically placed, the door body is in a closed state, and the connecting and rotating block 4 is clamped in the sliding groove 30 of the spring stress block 3 through the clamping mechanism; when the door body is pulled by external force, the door panel fixing frame 52 is first flipped upwards, and then the long arm support 50 is expanded outwards and drives the connecting and rotating block 4 to slide in the sliding groove 30 until the long arm support 50 pushes the door panel fixing frame 52 and the short arm support 51 to be in a parallel state; at this time, the door panel fixing frame 52 is flipped to be in a horizontal state, the door panel fixing frame 52 drives the door body to complete the opening action, the rotating and sliding arc edge 40 on the connecting and rotating block 4 is flipped to one side of the bottom of the sliding groove 30 and kept, and the door body completes the opening and holding action; and therefore, the telescopic arm assembly 5 arranged in the present invention can drive the door panel fixing frame 52 used for fixing the door body to realize the turning from a vertical position to a horizontal position through mutual matching of the long arm support 50 and the short arm support 51 through two-stage rotary bending, and the clamping mechanism arranged in the present invention can effectively keep the door panel fixing frame 52 in a vertical or horizontal state.

### Embodiment 2

The embodiment is different from embodiment 1 in that:

A damper 6 used for buffering the telescopic arm assembly 5 during retraction and extension is arranged in the hinge box body 1, and the damper 6 is rotationally connected with the connecting and rotating block 4.

The rotating point of the connecting and rotating block 4 and the hinge box body 1 is arranged in the center position of the connecting and rotating block 4, an arm shaft hole for rotary fixation of the telescopic arm assembly 5 is reserved in the panel of one side of the connecting and rotating block 4 near the telescopic arm assembly 5, one side of the arm shaft hole opposite to the center position of the connecting and rotating block 4 is provided with a damper shaft hole, the telescopic end of the damper 6 is rotationally connected with the connecting and rotating block 4 through the damper shaft hole, and the damper 6 is installed in the hinge box body 1.

The present invention has the working principle that: the damper 6 arranged in the present invention can slow down application of elastic force of the hinge spring 2 during turning to keep the telescopic arm assembly 5 slowly open or close as a whole, thus greatly improving the overall turning smoothness of the door panel fixing frame 52.

For those skilled in the art, apparently, the present invention is not limited to details of the above demonstrative embodiments. Moreover, the present invention can be realized in other specific forms without departing from the spirit or basic feature of the present invention. Therefore, in all respects, the embodiments shall be regarded to be demonstrative and nonrestrictive. The scope of the present invention is defined by appended claims, rather than the above description. Therefore, the present invention is intended to include all changes falling into the meaning and the scope of equivalent elements of claims within the present invention. Any drawing mark in claims shall not be regarded to limit the concerned claims.

In addition, it shall be understood that although the description is explained in accordance with the embodiments, not every embodiment only includes one independent technical solution. This narration mode of the description is only for clarity. Those skilled in the art shall regard the description as a whole, and the technical solution in each embodiment can also be appropriately combined to form other embodiments understandable for those skilled in the art.

What is claimed is:

1. An overhead door hinge mechanism, comprising a hinge box boy (1), wherein the side wall of the hinge box body (1) is provided with a telescopic arm assembly (5) used for connecting with the door backplane of an overhead door, the telescopic arm assembly (5) is provided with a two-stage rotating arm mechanism used for driving the door backplane to upwards flip over the range of a right angle, a connecting and rotating block (4) and a spring stress block (3) are rotationally fixed in the hinge box body (1), the telescopic arm assembly (5) is rotationally fixed on the side wall of the hinge box body (1) through the connecting and rotating block (4), and a clamping mechanism used for limiting the rotation of the connecting and rotating block (4) is arranged between the spring stress block (3) and the connecting and rotating block (4).

2. The overhead door hinge mechanism according to claim 1, wherein the spring stress block (3) is provided with a hinge spring (2) used for rotationally applying pressure on the spring stress block (3) on one side away from sliding connection with the connecting and rotating block (4).

3. The overhead door hinge mechanism according to claim 1, wherein the two-stage rotating arm mechanism comprises a long arm support (50), a short arm support (51) and a door panel fixing frame (52), the long arm support (50) and the short arm support (51) are rotationally fixed on the panel of one side of the connecting and rotating block (4) at an interval, the outside ends of the long arm support (50) and the short arm support (51) are fixed on one end of the door panel fixing frame (52) at an interval, and the panel of the door panel fixing frame (52) relative to the rotating connection of the long arm support (50) and the short arm support (51) is used for fixed connection with the door backplane of the overhead door.

4. The overhead door hinge mechanism according to claim 1, wherein a damper (6) used for buffering the telescopic arm assembly (5) during retraction and extension is arranged in the hinge box body (1), and the damper (6) is rotationally connected with the connecting and rotating block (4).

5. The overhead door hinge mechanism according to claim 1, wherein the clamping mechanism comprises a sliding groove (30) and a rotating and sliding arc edge (40), the rotating and sliding arc edge (40) is arranged in the side wall position connected with the connecting and rotating block (4) and the spring stress block (3), the sliding groove (30) is arranged in the side wall connected with the connecting and rotating block (4), the sliding groove (30) is an annular opening groove, the connecting and rotating block (4) is integrally clamped in the sliding groove (30) through the rotating and sliding arc edge (40), and a bearing ring for facilitating sliding of the connecting and rotating block (4) is sleeved in the sliding groove (30).

6. The overhead door hinge mechanism according to claim 2, wherein the clamping mechanism comprises a sliding groove (30) and a rotating and sliding arc edge (40), the rotating and sliding arc edge (40) is arranged in the side wall position connected with the connecting and rotating block (4) and the spring stress block (3), the sliding groove (30) is arranged in the side wall connected with the connecting and rotating block (4), the sliding groove (30) is an annular opening groove, the connecting and rotating block (4) is integrally clamped in the sliding groove (30) through the rotating and sliding arc edge (40), and a bearing ring for facilitating sliding of the connecting and rotating block (4) is sleeved in the sliding groove (30).

7. The overhead door hinge mechanism according to claim 3, wherein the clamping mechanism comprises a sliding groove (30) and a rotating and sliding arc edge (40), the rotating and sliding arc edge (40) is arranged in the side wall position connected with the connecting and rotating block (4) and the spring stress block (3), the sliding groove (30) is arranged in the side wall connected with the connecting and rotating block (4), the sliding groove (30) is an annular opening groove, the connecting and rotating block (4) is integrally clamped in the sliding groove (30) through the rotating and sliding arc edge (40), and a bearing ring for facilitating sliding of the connecting and rotating block (4) is sleeved in the sliding groove (30).

8. The overhead door hinge mechanism according to claim 4, wherein the clamping mechanism comprises a sliding groove (30) and a rotating and sliding arc edge (40), the rotating and sliding arc edge (40) is arranged in the side wall position connected with the connecting and rotating block (4) and the spring stress block (3), the sliding groove (30) is arranged in the side wall connected with the connecting and rotating block (4), the sliding groove (30) is an annular opening groove, the connecting and rotating block (4) is integrally clamped in the sliding groove (30) through the rotating and sliding arc edge (40), and a bearing ring for facilitating sliding of the connecting and rotating block (4) is sleeved in the sliding groove (30).
